(19) United States
(12) Patent Application Publication
(10) Pub. No.: US 2016/0071524 A1
(43) Pub. Date: Mar. 10, 2016

(54) Audio Modification for Multimedia Reversal

(71) Applicant: Nokia Corporation, Espoo (FI)

(72) Inventors: Mikko Tapio Tammi, Tampere (FI); Miikka Vilermo, Siuro (FI); Roope Jarvinen, Lempaala (FI); Jussi Virolainen, Espoo (FI); Juha Backman, Espoo (FI)

(21) Appl. No.: 14/480,835

(22) Filed: Sep. 9, 2014

(51) Int. Cl. G10L 21/02; G11B 27/00; H04N 9/87

(52) U.S. Cl. CPC G10L 21/0205; H04N 9/87; G11B 27/005

(57) ABSTRACT

An apparatus comprises a display module; an audio transducer; and electronic circuitry comprising a controller having a processor and at least one memory. The electronic circuitry is configured to reverse a video signal, separate an audio signal associated with the video signal into a first audio object and a second audio object, separate the first audio object into first audio blocks, separate the second audio object into second audio blocks, reverse the first audio object in a first reverse order, reverse the second audio object in a second reverse order, and sum the reversed first audio object in the first reverse order and the reversed second audio object in the second reverse order, the reversed video signal being played on the display module and the first and second audio blocks being played through the audio transducer.

### BACKGROUND

1. Technical Field

The exemplary and non-limiting embodiments disclosed herein relate generally to multimedia devices incorporating both video and audio signals and, more particularly, to devices and methods in which audio signals are modified during the playing of video segments in reverse in order to provide improved user control to the video reversal.

2. Brief Description of Prior Developments

Video playback is often reversed when a user needs to return to a desired point that was played earlier in the video. In reversing the video playback, audio signals associated with the video are typically muted or played in reverse without any processing. When the audio signals are played in reverse without processing, the signals are generally unintelligible.

### SUMMARY

The following summary is merely intended to be exemplary. The summary is not intended to limit the scope of the claims.

In accordance with one aspect, an apparatus comprises a display module, an audio transducer, and electronic circuitry. The electronic circuitry comprises a controller having a processor and at least one memory and is configured to reverse a video signal, separate an audio signal associated with the video signal into a first audio object and a second audio object, separate the first audio object into first audio blocks, separate the second audio object into second audio blocks, reverse the first audio object in a first reverse order, reverse the second audio object in a second reverse order, and sum the reversed first audio object in the first reverse order and the reversed second audio object in the second reverse order, the reversed video signal being played on the display module and the first and second audio blocks being played through the audio transducer.

In accordance with another aspect, a method comprises demultiplexing a video signal from an audio signal; reversing the video signal; separating the audio signal into at least two audio components; analyzing the separated audio signal components; determining whether the separated audio signal components comprise any of a non-speech component and a speech component; one or more of reversing the non-speech component and splitting the speech component into blocks; reversing a time-wise order of the blocks of the speech component; summing the one or more reversed non-speech component and the reversed time-wise order of the blocks of the speech component; and multiplexing the summed one or more reversed non-speech component and the reversed time-wise order of the blocks of the speech component with the reversed video signal component.

In accordance with another aspect, a method comprises receiving an audio signal having a speech component; splitting the speech component into audio objects; reversing a time-wise order of the audio objects of the speech component; and playing the reversed time-wise order of the audio objects of the speech component through an audio transducer.

### BRIEF DESCRIPTION OF THE DRAWINGS

The foregoing aspects and other features are explained in the following description, taken in connection with the accompanying drawings, wherein:

FIG. 1A is a front view of one exemplary embodiment of a hand-held portable multimedia apparatus;

FIG. 1B is a rear view of the apparatus of FIG. 1A;

FIG. 1C is a schematic representation of electronic circuitry of the multimedia apparatus;

FIG. 2 is a flowgraph of one exemplary embodiment of audio processing on the multimedia apparatus;

FIG. 3A is a graphical representation of audio and video signal components processed in the multimedia apparatus;

FIG. 3B is a graphical representation of the audio and video signal components with the audio signal component separated into speech components and other audio components;

FIG. 3C is a graphical representation of the audio and video signal components with the audio signal speech component separated into speech block boundaries;

FIG. 3D is a graphical representation of the audio and video signal components during reverse playback;

FIG. 4 is a flowgraph of one exemplary embodiment of audio processing of 5.1 surround sound on the multimedia apparatus;

FIG. 5 is a flowgraph of another exemplary embodiment of audio processing of 5.1 surround sound on the multimedia apparatus;

FIGS. 6A-6C are graphical representations of video editing in which audio signals are processed;

FIG. 7 is a flowgraph of one exemplary embodiment of audio processing of a cinemagraph; and

FIG. 8 is a graphical representation of audio processing of audio signals on a cinemagraph.

### DETAILED DESCRIPTION OF EMBODIMENT

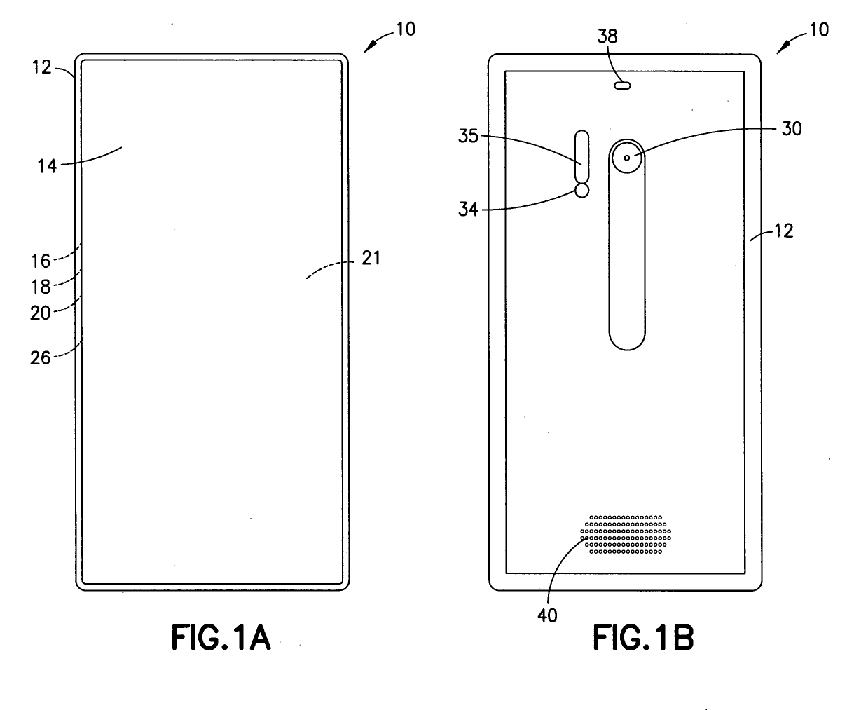

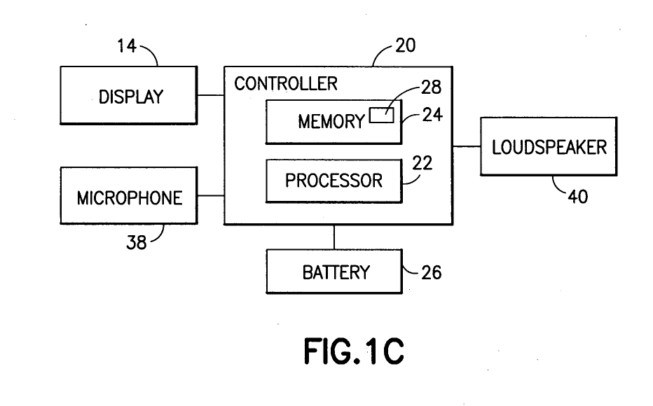

Referring to FIGS. 1A and 1B, one exemplary embodiment of an apparatus is designated generally by the reference number 10. Although the features will be described with reference to the example embodiments shown in the drawings, it should be understood that features can be embodied in many alternate forms of embodiments. In addition, any suitable size, shape, or type of elements or materials could be used.

The exemplary embodiments of the apparatus 10 are directed to multimedia devices controlled by electronic circuitry and in which video segments can be played in reverse with processing of accompanying audio signals. Any type of multimedia device capable of reversing the video playback is within the scope of the disclosed exemplary embodiments. Such multimedia devices include, but are not limited to, video players (e.g., DVD players and BLU-RAY players), television (e.g., Internet or “smart” television), cameras, mobile devices (e.g., cellular phones, tablets, and any other type of mobile device having communication capability), computers (e.g., laptops), and any other type of multimedia device capable of providing video playback.

The apparatus 10, in this example embodiment, comprises a housing 12, a video display module 14, a receiver 16, a transmitter 18, a speaker 40 or audio transducer, a controller 20, at least one printed wiring board 21 (PWB 21), and a rechargeable battery 26. The receiver 16 and transmitter 18, which may be provided in the form of a transceiver, define a primary communications system to allow the apparatus 10 to communicate with a wireless telephone system, such as a mobile telephone base station for example. Features such as a camera 30 having an LED 34 and a flash system 35, a microphone 38, and the like may also be included. However, not all of these features are necessary for the operation of the apparatus 10. For example, the apparatus 10 may function solely as a video player without the telephone communications system and without the camera features.

Referring to FIG. 1C, the electronic circuitry is mounted inside the housing 12 and may comprise the PWB 21 having components such as the controller 20 located thereon. The controller 20 may include at least one processor 22, at least one memory 24, and software 28.

In use of the apparatus 10 as a video player, reversing the playback is useful when a user wants to return to a previous point in a video being viewed. Such reversing of the playback is also useful with regard to the editing of special effects in videos and in cinemagraphs. In any type of reversed video playback, the hardware and software associated with the video component allow the video to be generally visible to a user. However, the corresponding audio portion associated with the reversed video is also reversed in such a way as to both give the user a feeling of returning to an earlier point in the video and keeping the most relevant audio content coherent.

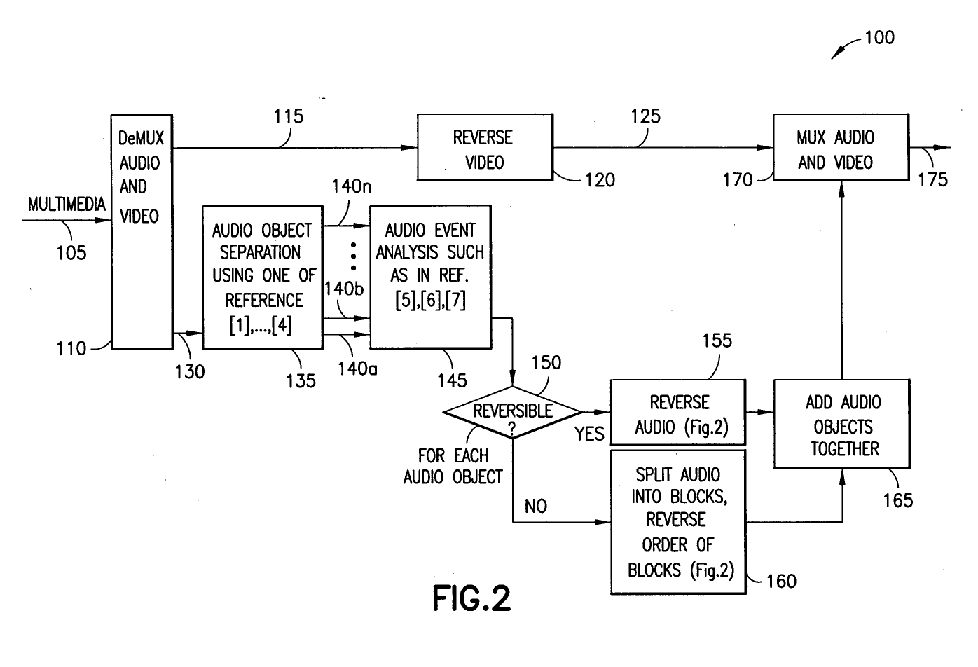

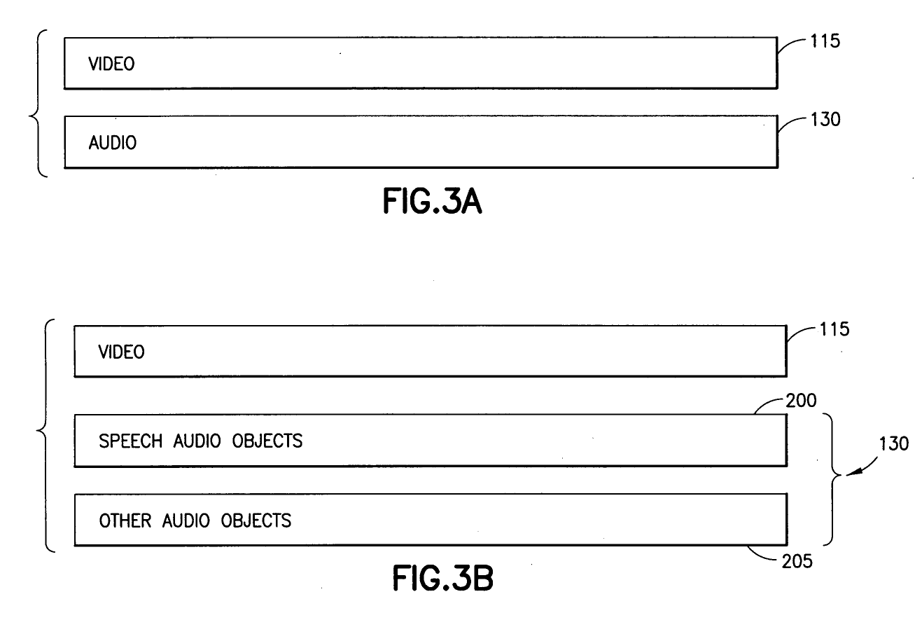

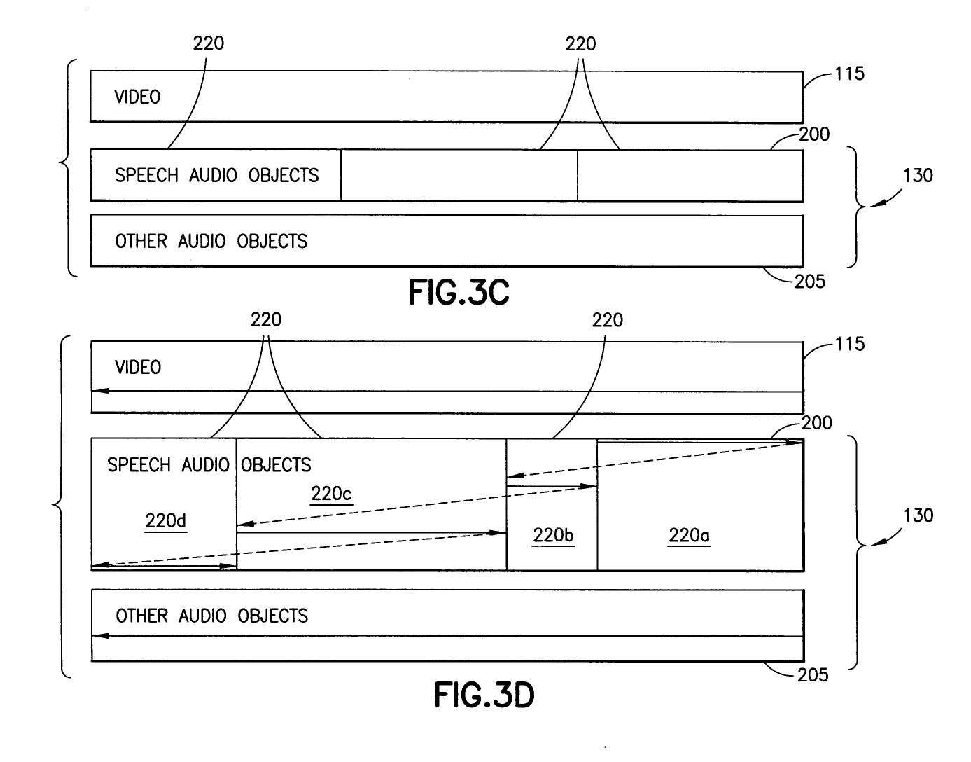

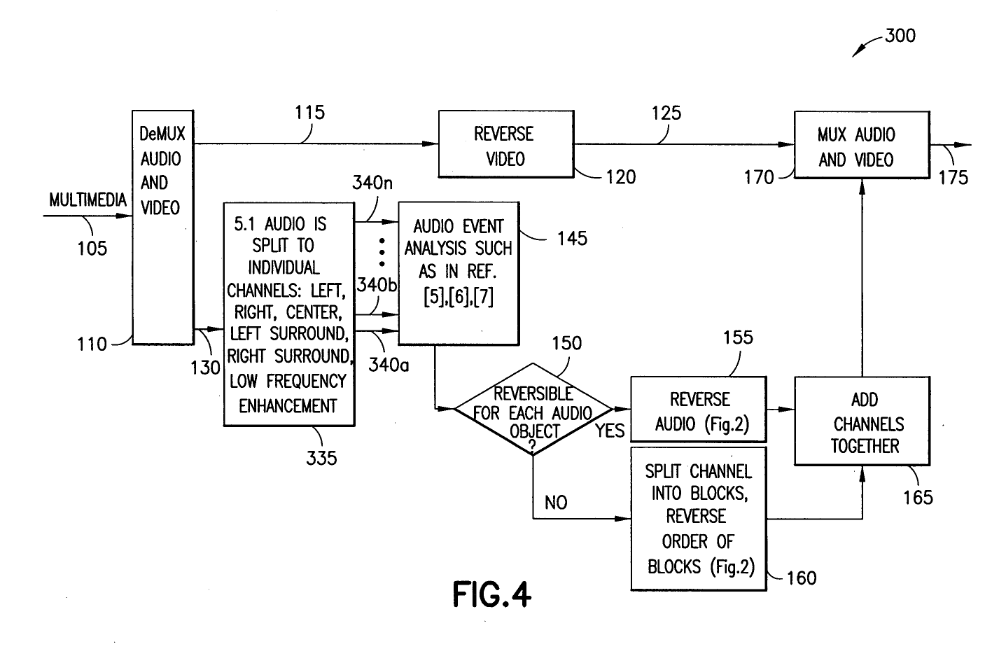

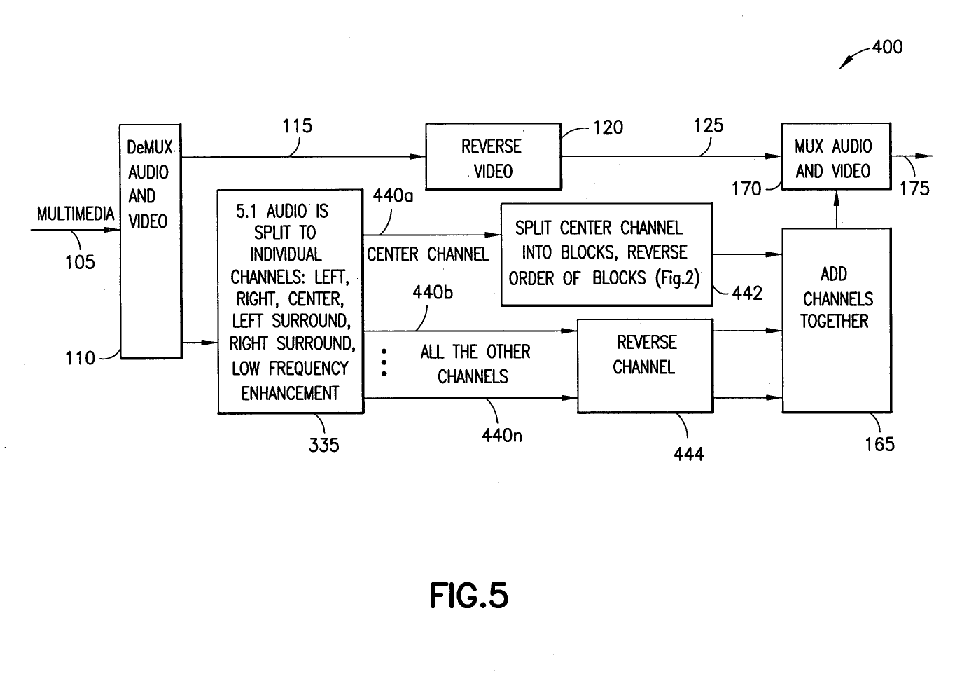

In referring to FIGS. 2-8, exemplary methods to reverse audio such that the intelligibility of the audio is retained are described herein. These methods separate audio signals into different audio objects, which are reversed differently based on the audio object characteristics.

The methods as described herein are used for generating coherent sound when a user is reversing (“rewinding”) a video. When reversing a video, the length of the section being reversed is not known in advance. When a user starts to reverse the video, a segment (e.g., the last 10 seconds) of the previous section of the video is processed by software, and the audio portion of the video is reversed. If the user rewinds less than the whole 10 second segment, reversed playback is interrupted. If the user rewinds longer than 10 seconds, another segment is processed and played back to the user in reverse.

Referring to FIG. 2, a flowgraph of one exemplary embodiment of the invention is designated generally by the reference number 100 and is hereinafter referred to as “flowgraph 100.” In flowgraph 100, an input 105 from a multimedia source defined by audio and video signals (e.g., a 10 second segment of video with accompanying audio) is processed in a demultiplex step 110 by a demultiplexer (DeMUX). The separated video signal (shown at 115) is then reversed in a video reverse step 120 to produce a reversed video 125.

The separated audio signal (shown at 130) is separated into discrete audio objects in an audio object separation step 135. The audio objection separation step 135 comprises blind source separation (BSS) of signals using finite impulse response (FIR) filters based on frequency domain independent component analysis (ICA), non-negative matrix factorization, or other algorithms.

Based on the results of the separation of the signals, the audio signal components (shown at 140a, 140b, . . . 140n) are then analyzed in an audio event analysis step 145 in order to confirm whether it is possible to reverse the audio object playback (for some audio signals, reversal is not possible). Speech objects are typically not reversed because speech does not generally sound pleasant if played backwards, but other objects (e.g., non-speech) are reversed. Thus, speech (or a similar transient signal) is most often reversed using the exemplary embodiments described herein, while non-speech (or a similar non-transient signal) is reversed in a conventional manner. Also, there may be more than one speech object (e.g., transient signals) and more than one non-speech object (e.g., non-transient signals), with all or some of the speech objects (for example, high energy signals) being reversed as described herein and all or some of the non-speech objects being reversed conventionally. Analysis of the audio signal components 140a, 140b, . . . 140n using the audio event analysis step 145 to detect speech content may be carried out using dedicated speech activity detection algorithms (voice activity detectors (VADs) such as that described in Harsha, B. V.: “A noise robust speech activity detection algorithm,” Proceedings of 2004 International Symposium on Intelligent Multimedia, Video and Speech Processing, Page(s): 322-325, 2004), which rely on various algorithms to segment input speech signals into frames of about 10 milliseconds in duration and subsequently calculate features such as full band energy, high band energy, residual energy, pitch, and zero-crossing rate.

Based on the results of the audio event analysis step 145, a decision 150 is made regarding whether the separated audio signal components 140a, 140b, . . . 140n can be reversed. Those audio signal components 140a, 140b, . . . 140n that can be reversed are reversed in a reverse audio step 155, and those audio signal components 140a, 140b, . . . 140n that cannot be reversed are not reversed. The audio signal components 140a, 140b, . . . 140n that cannot be reversed are processed in a split/reverse step 160 in which the audio signal components 140a, 140b, . . . 140n are split into blocks, and a time-wise order of the blocks is reversed. All audio signal components 140a, 140b, . . . 140n (reversed and not reversed) are then summed together in a summation step 165. The summed audio signal components 140a, 140b, . . . 140n from the summation step 165 are then combined with the reversed video 125 and multiplexed in a multiplex step 170 to produce an output 175.

Referring now to FIGS. 3A-3D, in some embodiments the audio signal components 140a, 140b, and 140n from the split/reverse step 160 that are not reversed (e.g., speech) are split into smaller segments, for example, at sentence or word boundaries. FIG. 3A shows the separated video signal 115 and the separated audio signal 130. FIG. 3B shows the separated audio signal 130 separated into speech audio objects 200 and other audio objects 205. As shown in FIG. 3C, in processing the speech audio objects 200 in the split/reverse step 160, speech block boundaries are determined. One method for detecting speech block boundaries is to search for inactive voice moments, for example, using a VAD for application to variable-rate speech coding. In this way, the entire audio segment representing the speech audio objects 200 can be split into shorter segments 220. Spoken sentence recognition and sentence boundaries can be determined using, for example, a time-synchronous parsing algorithm, such as that of Nakagawa, S.: “Spoken sentence recognition by time-synchronous parsing algorithm of context-free grammar,” IEEE International Conference on Acoustics, Speech, and Signal Processing, ICASSP '87, Page(s): 829-832, 1987. Also, using these processes music can be divided into shorter segments (e.g., bars). A bar of music in this context means a group of beats, the beats being detected using, for example, a compressed domain beat detector that uses MPEG-1 Layer III (MP3) encoded audio bitstreams directly in the compressed domain. As shown in FIG. 3D, the shorter segments 220 are then played back in a reverse order (the fourth shorter segment 220a being played first, then the third shorter segment 220b being played second, the second shorter segment 220c being played third, the first shorter segment 220d being played fourth, and so on). When the separated video signal 115 is played back in reverse, the signal representing the other audio objects 205 is also played back in reverse. However, the signal representing the speech audio objects 200 is played back in a forward direction with only the order of the shorter segments 220 being reversed. If each segment is a word, then the user will hear a coherent recitation of words, the order of the words representing a sentence in which the individual words are spoken in reverse order.

In another exemplary embodiment, instead of separating the speech audio objects 200 from the other audio objects 205, some signals can be played back normally with other signals being reversed. In particular, in applications of surround sound multichannel audio layout systems (such as 5.1, 7.1, 7.2, 11.2, etc. used in commercial cinemas and home theaters), the speech is usually in the center channel whereas other channels comprise the remainder of the audio content. With such audio it is typically sufficient to play all other channels reversed normally and the center channel comprising discrete blocks of audio signal in which the time-wise order of the blocks is reversed. In some applications, the content in other channels may benefit from the exemplary disclosed reversal method as well.

Referring now to FIG. 4, a flowgraph of how the reversal may be carried out for a 5.1 surround sound multichannel audio layout system in which all channels are analyzed for optimal reversal method is designated generally by the reference number 300 and is hereinafter referred to as “flowgraph 300.” Flowgraph 300 is similar to flowgraph 100, particularly with regard to video reversal. However, the audio object separation step 135 is modified to a channel split step 335 in which the separated audio signal 130 from the DeMUX is split into individual channels 340a, 340b, . . . 340n. For example, the various channels of the 5.1 surround sound multichannel audio are split into corresponding left, right, center, left surround, right surround, and low frequency enhancement channels. The split channels are then analyzed in the audio event analysis step 145 using dedicated speech activity detection algorithms to determine whether the speech can be reversed. Processing then proceeds as indicated in flowgraph 100 (splitting, time-wise reversing, and summation to produce the output 175).

Referring now to FIG. 5, a flowgraph of how the reversal may be carried out for a 5.1 surround sound multichannel audio layout system in which it is assumed that most speech content is located in the center channel is designated generally by the reference number 400 and is hereinafter referred to as “flowgraph 400.” In flowgraph 400, video reversal is similar to that as shown in flowgraph 100 and flowgraph 300. Processing of the audio signal involves the channel split step 335 in which the separated audio signal from the DeMUX is split into individual channels. In analyzing the split channels, the center channel (shown at 440a) is processed in a split/reverse step 442 in which the center channel 440a is divided into blocks and a time-wise order of the blocks is reversed. The remaining channels (shown at 440b through 440n) are processed in a reverse channel step 444. Once all the channels (center channel 440a and remaining channels 440b through 440n) are processed, the resulting signals are summed together in the summation step 165. The summed audio signal components from the summation step 165 are then combined with the reversed video 125 and multiplexed in the multiplex step 170 to produce the output 175.

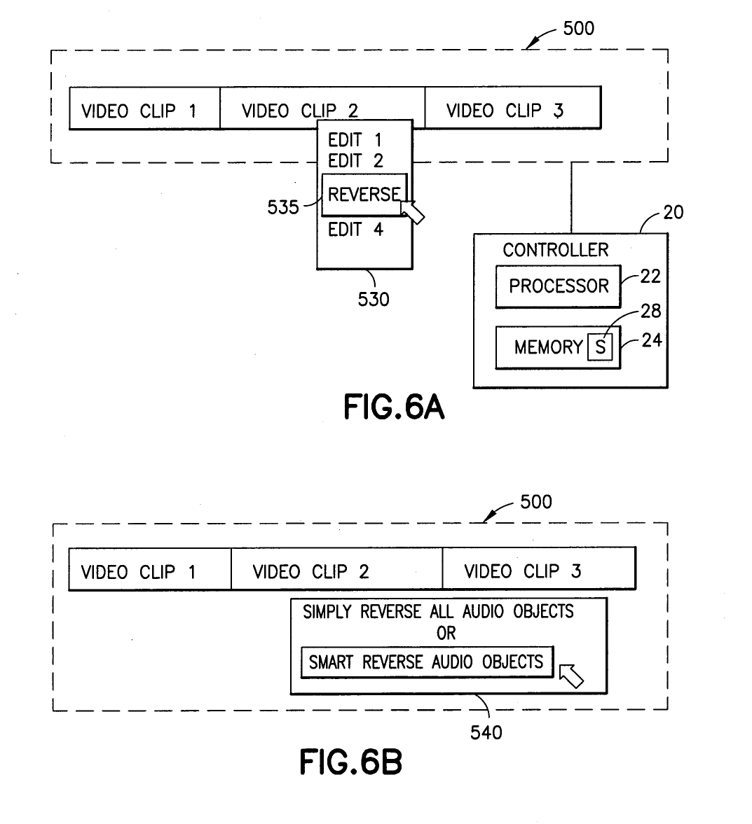

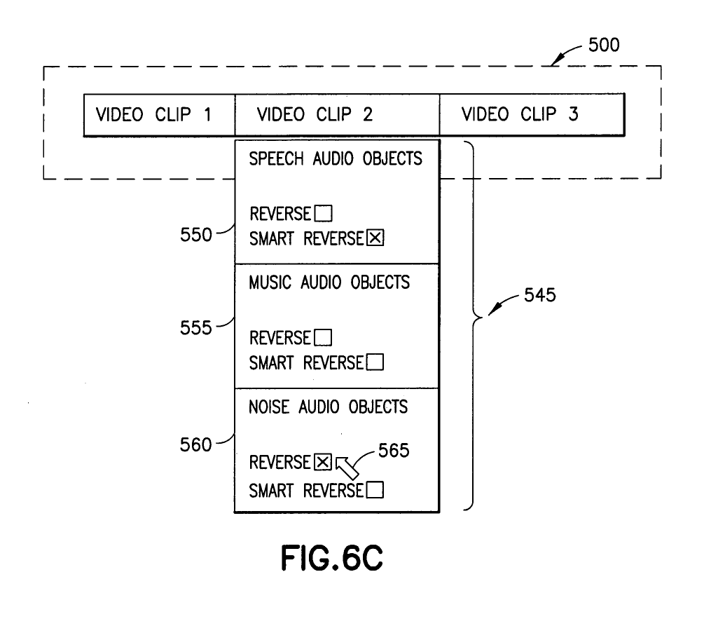

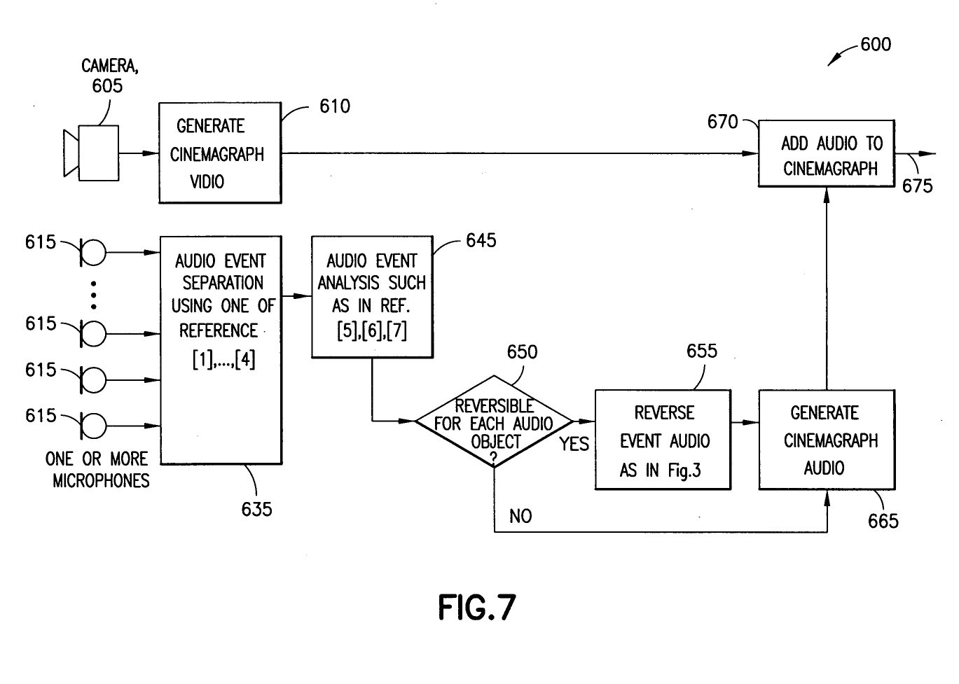

Referring now to FIGS. 6A-6C, it is also possible to incorporate the functionality of reversing the audio portion associated with a reversed video in a video editor 500 via a user interface. In such a video editor 500, a user may want to reverse a video segment or a part thereof. In the exemplary embodiments disclosed herein, the user is given an option to select which audio objects are reversed traditionally and which objects are reversed in a “smart” configuration as speech. As used herein, “smart” reversal means that the signal is divided into logical parts as sentences, phrases, words, or bars of music.

Referring specifically now to FIG. 6A, to reverse audio in the video editor 500, a user may be presented with segments of video, which are shown as video clip 1, video clip 2, and video clip 3. The video editor 500 may be controlled by the controller 20 having the processor 22 and the memory 24 and software 28. A drop down menu 530 may be incorporated into the video editor 500 to allow the user to select various options. As shown, the user may select an option to reverse 535 a selected video segment (for example, video clip 2 as shown).

Referring specifically now to FIG. 6B, selecting the option to reverse 535 a selected video segment presents a sub-menu 540 inquiring as to how the audio signal should be modified. In the exemplary embodiment described herein, selecting “Simply reverse all audio objects” plays back all audio reversed, and “Smart reverse audio objects” allows the user to choose which audio objects are reversed and which audio objects are played back as blocks of speech in which the time-wise order of, for example, individual words is reversed.

Referring specifically now to FIG. 6C, if the user chooses, for example, “Smart reverse audio objects,” the user may then be presented with various choices from a sub-sub-menu 545. Such choices include, but are not limited to, reversing or “smart” reversing a speech audio object 550, a music audio object 555, and a noise audio object 560. Using a point-and-click feature 565, the user may then select which audio objects are played back as speech.

In cases where strong music content is present in an audio signal, it may be desirable to not reverse the music while reversing all other content including speech. In this way, the music still sounds pleasant to the user, but the audio is also coherent with the backwards moving video when some audio content (other than music) is reversed. Strong music content can be detected, for example, by comparing the levels of the separated objects and making a decision that strong musical content is present if the sum of the levels of the audio objects that are recognized as music is greater than the sum of the levels of the other objects.

Referring now to FIG. 7, a flowgraph illustrating the reversal of audio for loops in cinemagraphs with movement reversal is designated generally by the reference number 600 and is hereinafter referred to as “flowgraph 600.” Cinemagraphs are image sequences that combine still and video image elements to produce an illusion of movement in a still image in which audio elements can be included. Cinemagraphs continuously repeat the same movement pattern. A specific feature in the movement is that in some cases the movement can be reversed, i.e. movement is played backwards in time.

In producing a cinemagraph using the process of the flowgraph 600, a camera 605 is used to capture movement for the cinemagraph. The captured video is then used to generate the cinemagraph in a cinemagraph generation step 610. Time and direction information pertaining to sound sources around the camera 605 is also recorded. Audio from the sound sources is captured by microphones 615 as audio events. Discrete audio events from a direction of interest are the ones which are separated from the background audio in a separation step 635. For this task, for example, spatial audio directional analysis can be used together with an audio focus feature, which concentrates capture of audio in the direction of interest. In the alternative, source separation based technologies can be used, and based on the directional information only sources in the directions of interest are separated from others.

In a second step, the separated content from the separation step 635 is analyzed in an audio event analysis step 645. The type of separated audio content is analyzed to determine if the audio playback can be reversed. For some audio signals reversal of playback is not possible. Analysis of the audio to detect speech content may be carried out using dedicated speech activity detection algorithms. The detection of speech can be performed using the method described in, for example, Harsha, B. V.: “A noise robust speech activity detection algorithm,” Proceedings of 2004 International Symposium on Intelligent Multimedia, Video and Speech Processing, Page(s): 322-325, 2004. Based on the results of the audio event analysis step 645, a decision 650 is made regarding whether the separated audio signal components can be reversed. If the separated audio signal is not reversible, reverse audio is not used, and audio editing of the cinemagraph is based, for example, on other technologies. In general most audio content other than speech can be played back in reverse order. Sounds that are particularly suited for reverse playback include sounds having sudden crash-like events.

In a third step, the audio for reversed movement is generated in a reverse audio step 655. If it is concluded from the audio event analysis step 645 that audio can be reversed, the reverse audio step 655 is performed for the separated audio from the separation step 635. The order of other audio components (background audio) is not reversed. Cinemagraph audio is then generated in an audio generation step 665. Reversed and background audio from the audio generation step 665 are then combined with and attached to the cinemagraph from the cinema generation step 670, and an output cinemagraph 675 is produced. Synchronization of audio and video is based on reversed audio and video content. In many cases, it may be reasonable to slightly set the play level of reversed audio down to avoid causing any artifacts, which are accidental or unwanted sounds caused by the processing of the audio. Artifacts may be at least partially hidden by playing back the signals with the most processing at a lower level, thereby masking the artifacts with the signals having the least amount of processing.

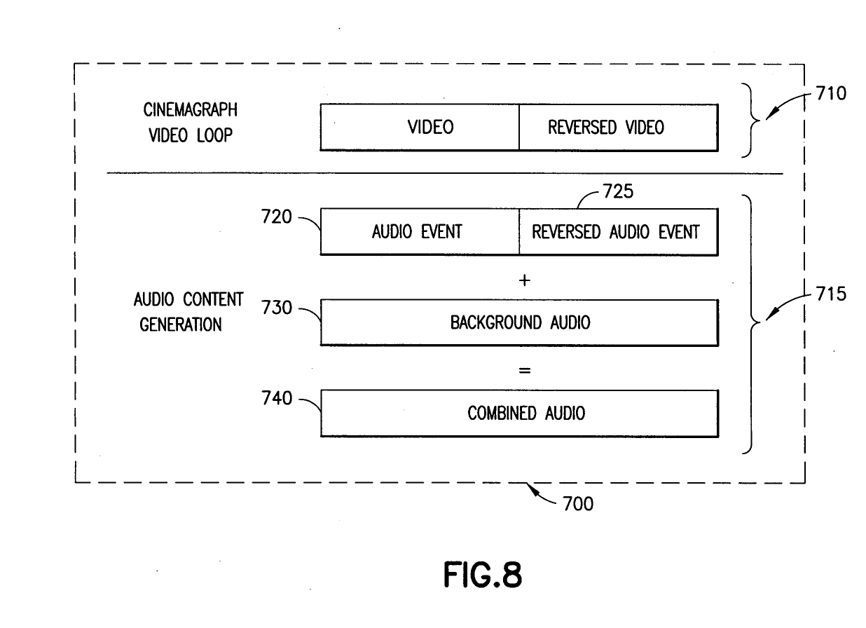

Referring now to FIG. 8, it is also possible to construct cinemagraphs in which the direction of movement changes during the loop. One exemplary embodiment of a cinemagraph loop is shown generally at 700, the cinemagraph loop 700 comprising a video loop 710 and an associated audio content generation loop 715. The audio content generation loop 715 comprises an audio event 720 with a reversed audio event 725 and a background audio segment 730, which when summed result in a combined audio segment 740. In the audio content generation loop 715, the direction of the audio should change with the direction of the cinemagraph loop 700 accordingly. The background audio segment 730 is utilized for the entire length of the cinemagraph loop 700. If the entire length of the cinemagraph loop 700 is not available, the background audio segment 730 can be defined by a combination of shorter segments.

In playback reversal or editing of a video or a cinemagraph, a reversed audio track may be generated such that background audio is not included at all. This enables focus on one particular sound source only.

With regard to both video and cinemagraph reversal, audio-related user interfaces are useful to provide the user with several processed options out of which the user can select the preferred option.

When rewinding a video, the speech audio objects can be played forward in, for example, blocks of segments, while the other audio objects are played reversed. Thus, playing the other audio objects in reverse gives the user the feeling of the video going backwards, and the audio objects are understandable so that the user can better follow how far the video has been reversed. The speech block boundaries may occur between words or sentences or at natural pauses in the speech. Therefore, the size of the speech blocks may vary from block to block. One method for detecting speech block boundaries is to process the speech using various algorithms that search for inactive voice moments using speech activity detection.

When a user is reversing the play of a video, currently the audio is not played at all or it is unintelligible gibberish. With the exemplary processes as disclosed herein, the audio is intelligible, and the user can better follow how far the video has been reversed even without looking at the screen. Typical use cases include, but are not limited to, viewing a video and wanting to return back to a specific part, listening to a user manual of a device and wanting to return back to an important part while looking more at the device than at the video, and the like. Additionally, the exemplary embodiments disclosed herein can be used to reverse audio intelligibly without an accompanying video, thereby allowing the user to “rewind” to a particular point in a song or other audio recording with ease.

The exemplary embodiments as disclosed herein are advantageous in that they add intelligibility to reversed video playback, make reversed audio more natural, allow the user to better follow how far the video has been reversed, provide new and entertaining features to video editing, and provide new and entertaining features to cinemagraphs.

In accordance with one aspect, an apparatus comprises a display module, an audio transducer, and electronic circuitry. The electronic circuitry comprises a controller having a processor and at least one memory and is configured to reverse a video signal, separate an audio signal associated with the video signal into a first audio object and a second audio object, separate the first audio object into first audio blocks, separate the second audio object into second audio blocks, reverse the first audio object in a first reverse order, reverse the second audio object in a second reverse order, and sum the reversed first audio object in the first reverse order and the reversed second audio object in the second reverse order, the reversed video signal being played on the display module and the first and second audio blocks being played through the audio transducer.

The electronic circuitry may comprise voice activity detection algorithms for analysis of the component of the audio signal associated with the video signal. The first audio object may be a speech object and the second audio object may be a non-speech object. The reversed first audio object in the first reverse order and the reversed second audio object in the second reversed order may be determined by a user. The reversed first audio object in the first reverse order and the reversed second audio object in the second reversed order may be determined by the electronic circuitry.

In accordance with another aspect, a method comprises demultiplexing a video signal from an audio signal; reversing the video signal; separating the audio signal into at least two audio components; analyzing the separated audio signal components; determining whether the separated audio signal components comprise any of a non-speech component and a speech component; one or more of reversing the non-speech component and splitting the speech component into blocks; reversing a time-wise order of the blocks of the speech component; summing the one or more reversed non-speech component and the reversed time-wise order of the blocks of the speech component; and multiplexing the summed one or more reversed non-speech component and the reversed time-wise order of the blocks of the speech component with the reversed video signal component.

The separating of the audio signal into at least two audio components may comprise using a blind source separation technique. The analyzing of the separated audio signal components may use a speech activity detection algorithm. The splitting of the speech component into blocks may comprise determining speech block boundaries based on inactive voice moments. The determining of speech block boundaries based on inactive voice moments may use a voice activity detector. The splitting of the speech component into blocks may comprise dividing music into groups of beats. The dividing of music into groups of beats may comprise detecting beats using a compressed domain beat detector that uses MP3 encoded audio bitstreams in a compressed domain. Reversing a time-wise order of the blocks of the speech component may be user-selectable. The video signal may be a cinemagraph.

In accordance with another aspect, a method comprises receiving an audio signal having a speech component; splitting the speech component into audio objects; reversing a time-wise order of the audio objects of the speech component; and playing the reversed time-wise order of the audio objects of the speech component through an audio transducer.

The splitting of the speech component into audio objects may be based on a detection of speech block boundaries determined by inactive voice moments. The method may also comprise playing the reversed time-wise order of the audio objects of the speech component with a video played in reverse. The video played in reverse may be a cinemagraph. The received audio signal may have a non-speech component. The method may further comprise separating the received speech component from the non-speech component.

Any of the foregoing exemplary embodiments may be implemented in software, hardware, application logic, or a combination of software, hardware, and application logic. The software, application logic, and/or hardware may reside in the video player (or other device). If desired, all or part of the software, application logic, and/or hardware may reside at any other suitable location. In an example embodiment, the application logic, software, or an instruction set is maintained on any one of various conventional computer-readable media. A “computer-readable medium” may be any media or means that can contain, store, communicate, propagate, or transport instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications, and variances which fall within the scope of the appended claims.

What is claimed is:

1. An apparatus, comprising:
a display module;
an audio transducer; and
electronic circuitry comprising a controller having a processor and at least one memory and being configured to reverse a video signal, separate an audio signal associated with the video signal into a first audio object and a second audio object, separate the first audio object into first audio blocks, separate the second audio object into second audio blocks, reverse the first audio object in a first reverse order, reverse the second audio object in a second reverse order, and sum the reversed first audio object in the first reverse order and the reversed second audio object in the second reverse order, the reversed video signal being played on the display module and the first and second audio blocks being played through the audio transducer.

2. The apparatus of claim 1, wherein the electronic circuitry comprises voice activity detection algorithms for analysis of the component of the audio signal associated with the video signal.

3. The apparatus of claim 1, wherein the first audio object is a speech object and the second audio object is a non-speech object.

4. The apparatus of claim 1, wherein the reversed first audio object in the first reverse order and the reversed second audio object in the second reversed order is determined by a user.

5. The apparatus of claim 1, wherein the reversed first audio object in the first reverse order and the reversed second audio object in the second reversed order is determined by the electronic circuitry.

6. A method, comprising:
demultiplexing a video signal from an audio signal;
reversing the video signal;
separating the audio signal into at least two audio components;
analyzing the separated audio signal components;
determining whether the separated audio signal components comprise any of a non-speech component and a speech component;
one or more of reversing the non-speech component and splitting the speech component into blocks;
reversing a time-wise order of the blocks of the speech component;
summing the one or more reversed non-speech component and the reversed time-wise order of the blocks of the speech component; and
multiplexing the summed one or more reversed non-speech component and the reversed time-wise order of the blocks of the speech component with the reversed video signal component.

7. The method of claim 6, wherein the separating of the audio signal into at least two audio components comprises using a blind source separation technique.

8. The method of claim 6, wherein the analyzing of the separated audio signal components uses a speech activity detection algorithm.

9. The method of claim 6, wherein the splitting of the speech component into blocks comprises determining speech block boundaries based on inactive voice moments.

10. The method of claim 9, wherein the determining of speech block boundaries based on inactive voice moments uses a voice activity detector.

11. The method of claim 6, wherein the splitting of the speech component into blocks comprises dividing music into groups of beats.

12. The method of claim 11, wherein the dividing of music into groups of beats comprises detecting beats using a compressed domain beat detector that uses MP3 encoded audio bitstreams in a compressed domain.

13. The method of claim 6, wherein reversing a time-wise order of the blocks of the speech component is user-selectable.

14. The method of claim 6, wherein the video signal is a cinemagraph.

15. A method, comprising:
receiving an audio signal having a speech component;
splitting the speech component into audio objects;
reversing a time-wise order of the audio objects of the speech component; and
playing the reversed time-wise order of the audio objects of the speech component through an audio transducer.

16. The method of claim 15, wherein the splitting of the speech component into audio objects is based on a detection of speech block boundaries determined by inactive voice moments.

17. The method of claim 15, comprising playing the reversed time-wise order of the audio objects of the speech component with a video played in reverse.

18. The method of claim 17, wherein the video played in reverse is a cinemagraph.

19. The method of claim 15, wherein the received audio signal has a non-speech component.

20. The method of claim 19, further comprising separating the received speech component from the non-speech component.
